(19) United States
(12) Patent Application Publication
(10) Pub. No.: US 2015/0146018 A1
(43) Pub. Date: May 28, 2015

(54) CAMERA SYSTEM WITH INDUCTIVE POWERING OF WIRELESS CAMERA TAGS

(71) Applicant: Tagnetics, Inc., Troy, OH (US)

(72) Inventors: Kenneth W. Kayser, Salem, VA (US); Jon M. Hager, Salem, VA (US)

(73) Assignee: Tagnetics, Inc., Troy, OH (US)

(21) Appl. No.: 14/088,989

(22) Filed: Nov. 25, 2013

(51) Int. Cl. H04N 5/232; G06F 3/00; H04N 5/225; H04N 1/00

(52) U.S. Cl. CPC H04N 5/23241; H04N 5/23293; H04N 1/00204; G06F 3/005; H04N 5/2252
USPC 348/207.1; 348/372; 348/333.01

(57) ABSTRACT

Wireless camera tags, inventory management systems with wireless camera tags, and methods for making and methods for using wireless camera tags are disclosed. A wireless camera tag is disclosed for a camera system with a mounting rail having one or more electrical conductors connected to a power source. The camera tag includes an outer housing for mounting to the mounting rail proximate the electrical conductors. A digital camera for generating image data signals is attached to the outer housing. An inductor coil is attached to the outer housing and electrically connected to the digital camera. The inductor coil inductively couples power from the electrical conductors of the mounting rail and transmits the power to the digital camera. The inductor coil may comprise an air core coil. The camera tag may further include a rectifier circuit, and a capacitor connected in parallel to the inductor coil to form a resonant circuit.

### TECHNICAL FIELD

The present disclosure relates generally to wireless digital cameras. For some embodiments, the present disclosure relates more particularly to monitoring systems that utilize an arrangement of wireless digital cameras to acquire real-time information.

### BACKGROUND

Most traditional retailers of goods (sometimes referred to as “brick-and-mortar” retailers) utilize a wide expanse of shelving systems to stock and display their goods for perusal and purchase by store customers. To enhance visual merchandising, it is oftentimes desirable to maintain stock levels of these display shelves at or as close as possible to their maximum levels. When the floor stock level of a particular product is depleted and, thus, the product is no longer on display, retail operators can lose significant revenue because some customers are unable to find the product they desire to purchase while other customers fail to purchase the product on impulse. Historically, retailers have employed human auditors (more commonly known as “store clerks”) to physically check store shelves for stock levels, to identify any low-stock or out-of-stock goods, and to label and restock these goods. More recently, retailers have hired outside consultants to audit their stores for out-of-stock conditions. Inventory management, including the presentation and maintenance of adequate levels of stock on display shelves, is a perpetual, labor-intensive, and error-prone process.

To minimize human labor in inventory management, a number of different electronic monitoring systems and sensing arrangements have been proposed for detecting when the floor stock level of a particular product is low or a particular product is out-of-stock. Some of these arrangements utilize pressure-sensitive shelving pads to detect and track the individual products placed on, and later removed from, a shelf. Other arrangements utilize mechanical followers to urge shelved products toward the front of the shelf, and then employ electro-mechanical or optical sensors to follow the movement of the products and/or detect when there is no longer any product left on the shelf. Also known are monitoring systems that utilize digital cameras for real-time verification and detection of the availability of goods displayed for sale.

These prior art systems all have shortcomings that have prevented them from gaining widespread acceptance and use. In monitoring systems that utilize digital cameras, for example, the cost and size of the individual cameras can be prohibitive. In addition, problems have been encountered in providing the requisite power to and retrieving data from each individual camera. In systems in which the digital cameras are hardwired, installation and removal of the cameras, e.g., for repositioning, repair, or replacement, is expensive and impractical. Systems which use exposed wires and connectors for the cameras are undesirable because they reduce the system's reliability and subject the system to damage from electrostatic discharges, spillage, and surface oxides. In a “wireless” system, a battery or other onboard power source is required for powering each wireless digital camera. Adding batteries to the cameras increases the cost of each camera and can make the overall system unaffordable for many applications. Moreover, since a single retail establishment may require hundreds if not thousands of digital cameras to perform the requisite inventory management, replacement of the batteries is time-consuming, costly and creates environmental concern.

### SUMMARY

Disclosed herein are camera systems, such as those used in inventory monitoring and management systems, with an arrangement of digital cameras that are wirelessly powered using inductive power. In one embodiment, a camera system includes one or more movable wireless camera tags that are detachably coupled to a rail system. Each camera tag comprises a printed circuit board (PCB) mounted digital camera, a microprocessor, a coupling coil, and a rectifier circuit. The rail system includes electrically conductive rails for powering the camera tags through inductive coupling of electrical power from power conductors on the rails to the coupling coil in the camera tag. Electrical power from the coil may be supplied directly to components in the tag, or may be used to charge an energy storage device, such as a rechargeable battery or a capacitor, in the tag. Each camera tag may optionally comprise a wireless signal transmitter (e.g., a WiFi module, an RFID tag, an NFC device, etc.) for transmitting data to and receiving control signals from a central computer system, or the control signals may be transmitted and received via the power conductors on the rail.

In one implementation, the camera tags are deployed within an inventory environment and generate image data signals. Image analysis techniques, including object recognition analysis, are applied to the image data signals to assess the presence, absence, quantity, location, orientation, other characteristic, singly or in any combination thereof, of a product within the inventory environment.

Aspects of the present disclosure are directed to a wireless camera tag for a camera system, which includes a mounting rail having one or more electrical conductors connected to a power source. The wireless camera tag includes an outer housing that is configured to mount to the mounting rail proximate the electrical conductor(s). A digital camera is attached to the outer housing and is configured to generate image data signals. The wireless camera tag also includes an inductor coil that is attached to the outer housing and is electrically connected to the digital camera. The inductor coil is configured to inductively couple power from the one or more electrical conductors of the mounting rail and transmit this power to the digital camera. The inductor coil may comprise an air core coil. Moreover, the wireless camera tag may also include a capacitor connected to the inductor coil to form a resonant circuit.

Other aspects of the present disclosure are directed to an inventory management system for monitoring the stock level of a product on a shelf, such as a display shelf of a brick-and-mortar retail store, the stock shelf of a warehouse, or other support structures and storage facilities for stowing goods. The inventory management system includes a mounting rail that is operatively mounted proximate to the shelf. The mounting rail includes a pair of electrical conductors that extend along the length of the mounting rail and are configured to connect to an external power source, such as the local electric utility, solar charged battery bank or generator. The inventory management system also includes a wireless camera tag with an outer housing that is detachably coupled to the mounting rail (e.g., can be readily removed without having to disassemble or physically damage the tag or rail). A digital camera, which is mounted at least partially inside the outer housing, is configured to generate image data signals indicative of a characteristic of a product on the shelf in the field of view (e.g., the presence, absence, quantity, location, orientation, etc., of the product). A resonant circuit, which is mounted at least partially inside the outer housing, is electrically connected to the digital camera. The resonant circuit may comprise an inductor coil, such as an air core coil, electrically connected in parallel with a capacitor. The resonant circuit is configured to inductively couple power from the electrical conductors of the mounting rail, and transmit this power to the digital camera. The wireless camera tag may further comprise a rectifier circuit that is electrically connected to the resonant circuit, e.g., intermediate the digital camera and resonant circuit, and is configured to convert alternating current (AC) power into direct current (DC) power for transmission to the digital camera.

Additional aspects of the present disclosure are directed to methods of manufacturing a wireless camera tag and methods of using a wireless camera tag. For example, a method is presented herein for assembling a wireless camera tag for a camera system with a mounting rail having electrical conductors connected to a power source. The method includes: providing an outer housing with a housing cover and a housing base, the outer housing being configured to mount to the mounting rail proximate the electrical conductors; seating a printed circuit board (PCB) assembly on the housing base, the PCB assembly including a PCB, a digital camera mounted on the PCB and configured to generate image data signals, a wireless signal transmitter mounted on the PCB and configured to transmit the image data signals generated by the digital camera, a capacitor mounted on the PCB, and a diode bridge mounted on the PCB and electrically connected in parallel with the capacitor; attaching an air core coil to the PCB assembly such that the air core coil is electrically connected in parallel with the capacitor, the air core coil being configured to inductively couple power from the electrical conductors of the mounting rail, and transmit the power to the digital camera via the capacitor and the diode bridge; and, rigidly securing the housing cover to the housing base such that the PCB assembly and the air core coil are secured at least partially inside the outer housing.

The above summary is not intended to represent each embodiment or every aspect of the present disclosure. Rather, this summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of a portion of a representative inventory monitoring and management system in accordance with aspects of the present disclosure.

FIG. 2 is a partially exploded perspective-view illustration of the exemplary wireless camera tag shown in FIG. 1.

FIG. 3 is an enlarged perspective-view illustration of the wireless camera tag of FIG. 1 shown with the housing cover removed to more easily see the printed circuit board (PCB) assembly and the air core coil of the wireless camera tag.

FIG. 4 is a schematic illustration of some of the electrical components of the wireless camera tag of FIG. 1.

FIG. 5 is a flow chart of a routine that uses successive camera images to monitor reductions in the number of products on display.

FIG. 6 is a flow chart of a routine that uses successive images captured by a tag camera to control the activation and de-activation of supplemental display features such as increased lighting and/or looping video displays.

While this invention is susceptible to various modifications and alternative forms, specific embodiments have been shown by way of example in the drawings and will be described in detail herein. It should be understood, however, that the invention is not intended to be limited to the particular forms illustrated in the corresponding drawings. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

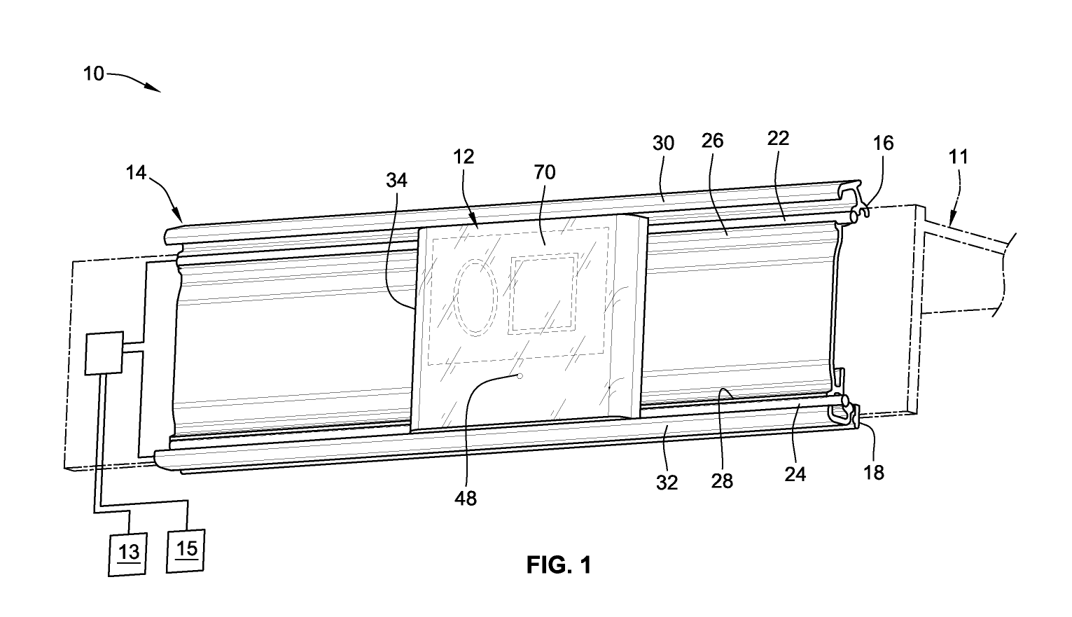

Referring now to the drawings, wherein like reference numbers refer to like components throughout the several views, there is shown in FIG. 1 a representative camera system, designated generally as 10, in accordance with aspects of the present disclosure. The camera system 10 generally comprises a representative wireless camera tag 12 that is mounted onto a representative mounting rail 14. The camera system 10 of FIG. 1 is described herein in the context of an inventory monitoring and management system for monitoring the stock levels of display shelves of a brick-and-mortar retailer, which is intended solely to offer a representative application by which some of the novel aspects and features of the present invention may be incorporated and practiced. Accordingly, the present invention is by no means limited to this particular configuration and application, and could just as easily be utilized in other monitoring applications (e.g., monitoring display stands, display bins, storage rooms, warehouses, and/or other storage containers and facilities) and non-monitoring applications (e.g., for identification, recordation, documentation, and/or security purposes). Moreover, only select components of the camera system 10 have been shown and will be described in additional detail hereinbelow. Nevertheless, the systems and devices discussed herein can include numerous additional and alternative features, options, and other well-known peripheral components without departing from the intended scope and spirit of the present invention. In addition, the drawings presented herein are not necessarily to scale and are provided purely for explanatory purposes. Thus, the individual and relative dimensions shown in the drawings are not to be considered limiting unless explicitly stated otherwise in the claims.

Generally designated at 11 and illustrated with ghost lines in FIG. 1 is a display shelf, which may be part of a bank of shelves, of the type typically used by retail stores for stocking and displaying a multiplicity of products to customers, in a manner that the customer can conveniently remove any selected product from the shelf on which that product is stocked. In the illustrated embodiment, each shelf 11 is equipped with an electrical communication and power distribution system that is coupled to one or more wireless camera tags 12 and, optionally, one or more electronic display tags (not shown) that are mounted onto the rail 14. The mounting rail 14 may be mounted on and extend along the front edge of the shelf 11, as shown, or may be mounted on and extend along an inside rail extending along the rear edge of the shelf 11, or may be mounted on an adjacent wall or other support structure in operative proximity to the shelf 11. Optionally, a specially designed bracket may be required for mounting the mounting rail 14 to the shelf 11; one such bracket is disclosed in U.S. Pat. No. 6,409,132 B2, to Jon C. Heisler et al., which is incorporated herein by reference in its entirety and for all purposes.

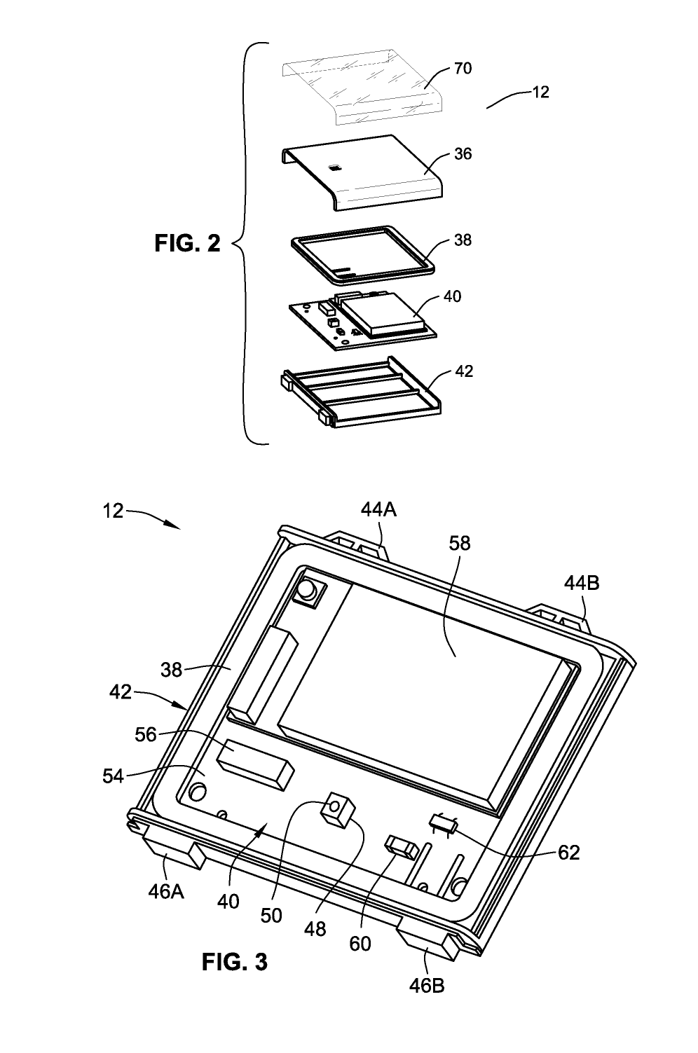

In the illustrated example, the mounting rail 14, which may desirably be fabricated from a semi-rigid but flexible synthetic polymer, includes an upper arcuate lip 16 that is vertically spaced from a lower arcuate lip 18, both of which project rearwardly from a rear surface of the rail 14. Each of the lips 16, 18 defines an elongated slot within which is received a respective portion of the shelf 11 such that the mounting rail 14 securely couples to the shelf 11. Alternatively, the aforementioned specially designed bracket (not shown; but see bracket 10 in FIGS. 1 and 2 of the '132 patent) includes a central body portion with an upwardly extending upper flange and a downwardly extending lower flange, wherein the flanges are shaped to be received in the grooves formed by the upper and lower rearward lips 16, 18 of the rail 14. To provide a more secure construction, the mounting rail 14 can be attached to the bracket by heat staking, threaded fasteners, etc. The bracket, in turn, is fixed to the shelf 11 (e.g., by flanges 28, 30 in FIGS. 1 and 2 of the '132 patent) to thereby couple the mounting rail 14 to the shelf 11.

Electrical conductors 22 and 24 extend transversely across the front of the shelf 11 along the length of the mounting rail 12 in operative proximity to the wireless camera tag 12. A first of the electrical conductors 22 is nested inside a first conductor pocket 26 formed in the mounting rail 14 adjacent an upper arcuate bar 30, while a second of the electrical conductors 24 is nested inside a second conductor pocket 28 formed in the mounting rail 14 adjacent a lower arcuate bar 32. As seen in FIG. 1, the upper and lower arcuate bars 30, 32 are vertically spaced from one another, each projecting upwardly and forwardly from a respective opposing end of the mounting rail 14. The first and second electrical conductors 22, 24 are connected to an electrical power source 13 and, optionally, to a central processing unit (CPU) 15 to carry power and, optionally, communication signals across the mounting rail 14. The conductors 22, 24 of FIG. 1 may be coupled in a loop to function as a primary winding for electromagnetically coupling to a secondary winding packaged inside each of the one or more tags mounted on the rail 14. As will be discussed in further detail below, these primary and secondary windings form electromagnetic transformers that transfer power from the power source 13, through the conductors 22, 24, to the wireless camera tags 12 and electronic display tags on the mounting rails 14. The CPU 13, which may represent or be a constituent part of an external data-processing system, can include any suitable processor(s) and micro-processor(s), can be connected to a main memory device (not shown), and may comprise any combination of hardware, software, or firmware necessary to provide the functionality described herein. The power and control system of FIG. 1 may take on various forms and configurations, some examples of which are disclosed in U.S. Pat. Nos. 5,537,126, 5,736,967, 6,089,453 and 6,181,299, all of which are incorporated herein by reference in their respective entireties and for all purposes.

In the illustrative embodiment, the mounting rail for the camera tag is on a display shelf, but it will be understood that the mounting rail can be located proximate other types of display elements, such as wire baskets or peg boards on which products are displayed by suspending them on peg hooks.

With reference to FIGS. 1 and 2, the wireless camera tag 12 includes an outer housing 34 that is configured to mount onto the mounting rail 14 proximate the electrical conductors 22, 24. According to the illustrated embodiment, the outer housing 34 is a polymeric, bipartite construction comprising a housing cover 36 (or “tag front”) that is rigidly secured to a housing base 42 (or “tag back”). It may be desirable, for some preferred embodiments, to laser weld the housing cover 36 to the housing base 42 such that the internal hardware of the tag 12—e.g., an inductor coil 38 and a printed circuit board (PCB) assembly 40—is sandwiched between the cover and base 36, 42 and thereby sealed inside the outer housing 34. It should be readily recognized that the material, size, geometry, and number of constituent parts of the outer housing 34 can be modified from that which is shown in the drawings.

Once assembled, the outer housing 34 is designed to detachably slidably couple to the mounting rail 14. In particular, the illustrated outer housing 34 configuration allows the wireless camera tag 12 to be readily mounted to and removed from the mounting rail 14 without having to use adhesives, fasteners, or hand tools, and without having to disassemble or physically damage the tag 12 or rail 14. As seen in FIG. 3, for example, the housing base 42 includes a plurality of mounting projections, namely a pair of top projections 44A and 44B protruding substantially orthogonally from a top surface of the housing base 42, and a pair of bottom projections 46A and 46B protruding substantially orthogonally from a bottom surface of the housing base 42 on the opposite side of the housing 34 from the top projections 44A, 44B. To mount the wireless camera tag 12 to the shelf 11, the bottom projections 46A, 46B can first be seated inside the channel formed by the lower arcuate bar 32 of the mounting rail 14. The tag 12 can then be rotated rearwardly (e.g., clockwise in FIG. 1) until the top projections 44A, 44B press against the upper arcuate bar 30. Under this force, the polymeric mounting rail 14 will flex such that the upper and lower arcuate bars 30, 32 deflect away from one another a sufficient distance to allow the top projections 44A, 44B to seat inside the channel formed by the upper arcuate bar 30. Once the projections 44A, 44B are situated, elasticity will return the mounting rail 14 to its original shape, thereby securing the wireless camera tag 12 to the rail 14 and, thus, the shelf 11.

In the illustrated embodiment, a PCB mounted digital camera 48 is at least partially disposed inside the outer housing 34 of the wireless camera tag 12 such that the camera lens 50 is aligned with a viewing hole defined through the front surface of the housing cover 36. The digital camera 48 is attached to the housing base 42, e.g., via alignment pins that mate with the PCB board 54 of the PCB assembly 40. The digital camera includes a microprocessor that converts the image to a numerical signal that can either be transmitted wirelessly or transferred to an optional microcontroller 56 installed on the camera tag PCB. When operating as a digital electronic still camera, for example, the digital camera 48 uses an electronic optical sensor, e.g., in conjunction with a diaphragm, an optical aperture, and a shutter mechanism, to capture reflected image light of an object within its field of view. Through cooperation with the onboard microcontroller 56, the digital camera 48 is configured to generate image data signals that are indicative of, for example, one or more characteristics of a product within the inventory environment, on demand.

The onboard microcontroller 56 may also provide additional image signal processing and/or compression techniques, to reduce the data that is transferred wirelessly or through the rail communication system. The data may be indicative of a variety of desired characteristics, such as the presence, absence, quantity, location, orientation, or other characteristic, singly or in any combination thereof, of a product on a display shelf in front of the wireless camera tag 12. It may be desirable, in some applications, that the digital camera 48 be controlled, e.g., via the CPU 15 in conjunction with the microcontroller 56, to take black-and-white still photographs on a predetermined cycle (e.g., one every four minutes), on demand (e.g., via CPU or operator command), or both. In addition or as optional alternatives to taking black-and-white stills, it may be desirable that the digital camera 48 be configured and operable to take color stills and/or video images. The microcontroller may be controlled by a pricing management system coupled to the microcontroller either wirelessly or via the coupling coil and the conductors on the mounting rail.

An onboard memory device (not shown), which can be in the nature of any machine-readable storage media, including read only memory (ROM), random access memory (RAM), flash memory, firmware memory, etc., may store the image data generated by the digital camera 48 and the sensing and processing instruction sets read and carried out by the microcontroller 56. While the wireless camera tag 12 may comprise an onboard memory device for storing the image data, it is desirable for some applications that the wireless camera tag 12 minimize or eliminate onboard memory storage capacity by transmitting the image data wirelessly to an external data-processing system. Onboard storage capacity can be limited, for example, to microcontroller and signal transmitter application software. In so doing, the wireless camera tag 12 is kept “thin” to reduce size, weight, energy consumption, heat generation, and cost.

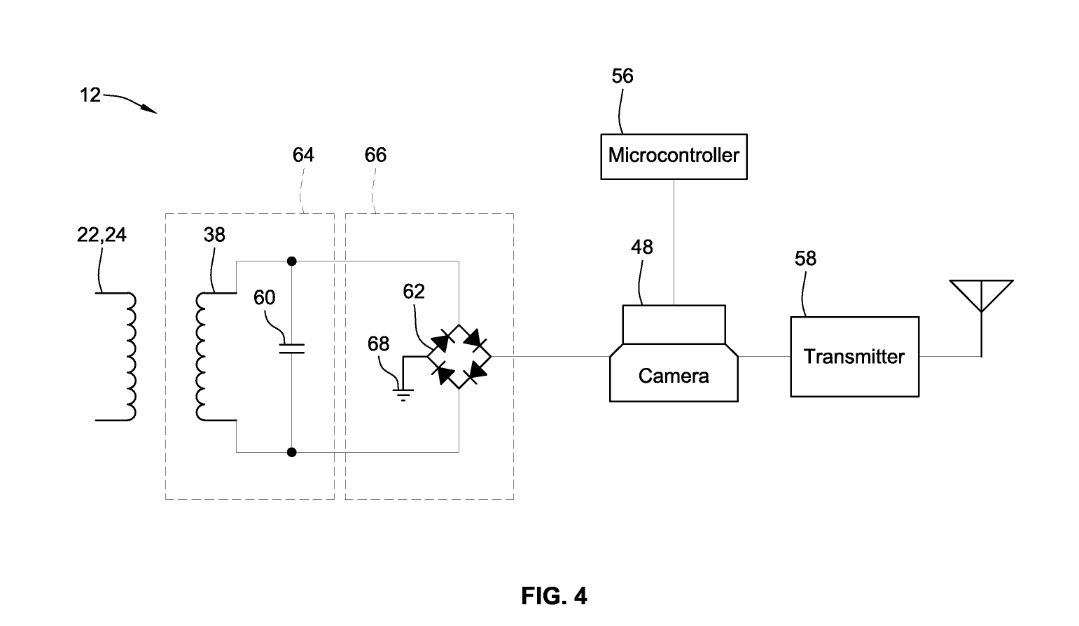

The wireless camera tag 12 also includes an inductor coil 38 that is disposed inside the outer housing 34 and electrically connected to the digital camera 48 through the PCB. After the PCB assembly 40 is seated against and attached to the housing base 42, e.g., via the alignment pins that mate with the PCB board 54, the inductor coil 38 is connected to the PCB and seated to the housing base such that the coil 38 circumscribes the PCB board 54 holding the digital camera 48, the microcontroller 56, a wireless signal transmitter 58, a capacitor 60, and a diode bridge 62. Once properly aligned, the inductor coil 38 is mounted to the housing base 54, e.g., via adhesives, and electrically connected, e.g., via soldering, to the capacitor 60 and diode bridge 62 and, thus, to the digital camera 48 and wireless signal transmitter 58, as seen in FIGS. 3 and 4.

Acting as the secondary winding in an electromagnetic transformer, as described above, the inductor coil 38 is configured to inductively couple power from the electrical conductors 22, 24 of the mounting rail 14, and transmit this inductively coupled power to the digital camera 48 and the wireless signal transmitter 58. In the embodiment illustrated in FIG. 3, the inductor coil 38 is an air core coil. In general, an air core coil is an electromagnetic inductor that does not depend upon a ferromagnetic material to achieve a specified inductance; rather, the coil consists essentially of multiple windings of a conductive material such as copper coated with an insulating material, e.g., varnish, plastic coating, PTFE, etc. Alternative embodiments may use traditional windings made from ferromagnetic materials. As seen in FIG. 4, the inductor coil 38 can be electrically connected in parallel with the capacitor 60 to form a resonant (LC) circuit 64, which is particularly well suited for picking up an electrical signal at a particular (resonant) frequency from a more complex signal in a loop.

The power inductively coupled from the electrical conductors 22, 24 by the inductor coil 38, and subsequently transmitted by the resonant circuit 64 is alternating current (AC) power. Since the digital camera 48 and the wireless signal transmitter 58 of the illustrated embodiment operate on direct current (DC), the wireless camera tag 12 includes a rectifier circuit 66 that is electrically connected to the resonant circuit 64 and configured to convert the AC power into DC power for transmission to the camera 48 and transmitter 58. The rectifier circuit 66 of FIG. 4 includes a diode bridge 62 connected to ground 68. The diode bridge 60 is mounted with a capacitor 60 on the PCB board 54 connected to the inductor coil 38 and electrically connected in parallel with the capacitor 60 via the PCB board 54.

The wireless signal transmitter 58 is configured to transmit the image data signals generated by the digital camera 48 to a processor of an external data-processing system (e.g., the CPU 15 or a separate computing device) via either an in-store network or via an external network such as the Internet. Thus, the wireless signal transmitter 58 may take on any known form of wireless transmitter/receiver, such as a Bluetooth® or WiFi (wireless fidelity) module, a Near Field Communication (NFC) device, etc. Continuing with the exemplary application for the camera system 10 of FIG. 1, the CPU 15 wirelessly receives the image data signals generated by the wireless camera tag 12, and determines from this image data via pattern recognition techniques desired information about the surrounding inventory environment. By way of non-limiting example, image analysis techniques, including object recognition analysis, are applied to the image data signals to assess the presence, absence, quantity, location, orientation, or other characteristic, singly or in any combination thereof, of a product on a shelf within the inventory environment. The digital camera 48 can be operational to take still pictures at set intervals, anywhere from once every few minutes to once an hour or every few hours, or at lesser or greater frequencies. The wireless camera tag 12 will send pixel data to a central server (located in the store or at a remote location), TAC or other access point. The transmitted data may be raw data or some preprocessing, such as data compression, may be performed prior to transmission.

After being transmitted from the wireless camera tag 12 via the wireless signal transmitter 58, software algorithms in the CPU 15 compare the received image(s) to master reference data (“master images”) stored in memory. Through this image comparison, it can be determined, for example, if an adjacent display shelf is low on stock, if the display shelf is out of stock, if the display shelf facing is in disarray, and/or if there is stocking creep by a neighboring product. When remedial action is needed, a notification is automatically sent to the appropriate store personnel and/or an indicator such as a small flashing light can be activated on the shelf section that needs attention. For some applications, such as out-of-stock detection, the image data can be processed in the tag, e.g., by comparing a current digital image with a reference image stored in memory in the tag. The status of all the shelves in a store can be conveniently displayed in a dashboard on a network interface, and alert signals or messages can also be sent to specific personnel in the store or at remote locations. In one implementation, the image itself and/or alert signals or messages may be transmitted to store personnel via email or text message.

The digital images transmitted from the cameras throughout a retail store can be used in monitoring the integrity of the store's planogram or “POG,” which is a diagram that shows how and where specific retail products should be placed on retail shelves or displays, to increase customer purchases. For example, a planogram may document how high or low on a shelf a product should be displayed, as well as which products should surround it, which in turn allows the management of a retail store to control how products are displayed and to track and improve on the success of a planogram for individual products. Detailed information about each product, such as the amount of inventory left on the shelves for the product at selected time intervals, can assist in improving a planogram over time. Such information can be derived from the digital images transmitted from the camera tags and any additional logic associated with the secondary image processing in the illustrative system.

Other types of analyses of the image data can be used for monitoring and planning shelf facing organization, for security monitoring, and for profiling customers.

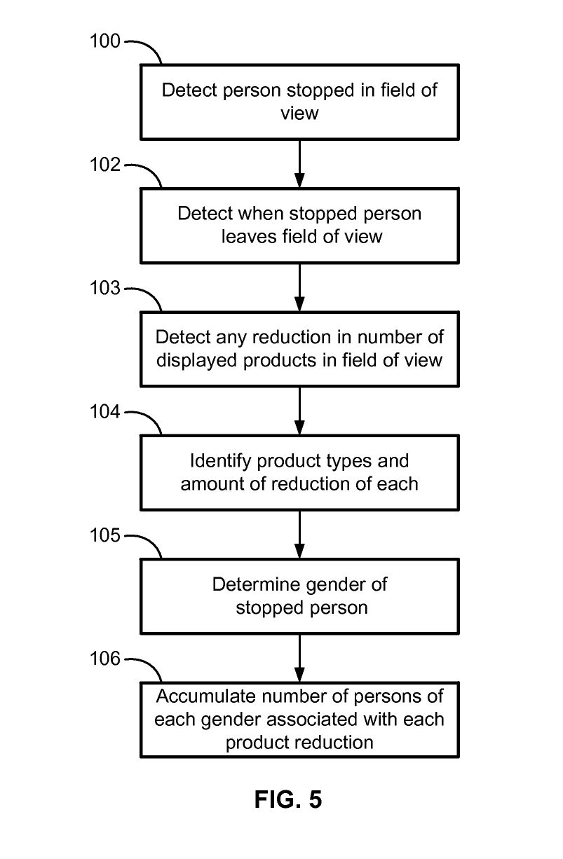

FIG. 5 is a flow chart of a routine that uses successive camera images to monitor reductions in the number of products on display. This routine begins at step 100 by comparing successive images captured by a camera to detect when a person stops in the field of view of that particular area. This image comparison may be executed by the processor in the camera tag, or by a processor at a remote location that receives the digital images captured by the cameras. Step 102 then detects when the stopped person leaves the field of view, and step 103 detects any reduction in the number of displayed products by comparing the number of products in the images captured before and after the last person stopped in the field of view of the camera. Alternatively, the number of products remaining after departure of the last person to stop can be compared with a planogram of the desired display of products within the field of view of the camera that captured the images being analyzed, to determine the difference between the number of products remaining on display and the desired maximum number represented by the planogram. If more than one type of product is displayed in the field of view of the camera, step 104 determines the reduction in the number of each product type.

Steps 105 and 106 depict a further option that uses an object recognition algorithm to determine the gender of each person that stops before a reduction in the number of displayed products, and then accumulates the number of people of each gender responsible for the reduction of each product type, for use in global marketing activities.

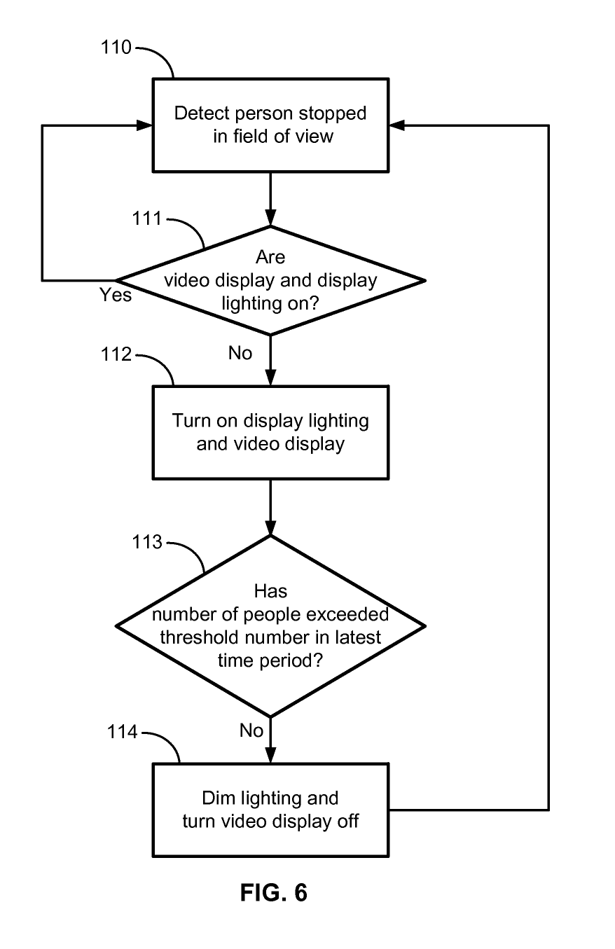

FIG. 6 is a flow chart of a routine that uses successive images captured by a tag camera to control the activation and de-activation of supplemental display features such as increased lighting and/or looping video displays. Such display features are used to increase sales, but they also consume extra power. The extra power consumed by such features can be reduced by activating them only when a person stops in that particular display area, and then automatically de-activating them. In the flow chart of FIG. 6, the first step 110 compares successive images captured by a camera to detect when a person stops in the field of view of that particular area. Here again, this image comparison may be executed by the processor in the camera tag, or by a remotely located processor that receives the digital images captured by the cameras. When step 110 detects a stopped person, step 111 determines whether the supplemental display feature(s) for that display area are turned on. If the answer is “yes” at step 111, the routine returns to step 110 to await the detection of the next person to stop in that display area. If the answer at step 111 is “no,” the routine advances to step 112 to turn on the supplemental display lighting and the video display for that particular display area. The supplemental display features then remain on, and step 113 determines whether the number of people passing through the display area has exceeded a preselected threshold number in a preselected time period, e.g., 10 people in a 2-minute time period. If the answer is “no,” the supplemental display features are de-activated at step 114, e.g., by dimming the lighting and turning off the looping video display, and then returning to step 110. An alternative for step 113 is to simply determine when a preselected time period has elapsed since the detection of the last person to stop in the display area being monitored.

For some embodiments, it may be desirable that the wireless camera tag 12 lack an onboard power source, such as a battery, mounted inside the outer housing 54. It may also be desirable that the wireless camera tag 12 lack an externally mounted electrical port or electrical connector for electrically coupling to an external power source. By eliminating these features, the wireless camera tag 12 is kept “thin” with a reduced size, weight, and cost. Optionally, the wireless camera tag 12 may include a backup energy storage device, such as a capacitor or battery, and/or an electrical connector (plug/port) for recharging an onboard rechargeable primary energy source such as a rechargeable battery or capacitor for powering the wireless digital camera and enabling the transmission of large amounts of image data. While the wireless camera tag 12 is typically powered by electrical conductors 22, 24 in the power and control portions of the camera system 10, the tag 12 may need a short peak energy source to transmit data through WiFi (but not to communicate commands nor to take pictures).

Other optional hardware for the wireless camera tag 12 may include a display area 70 on the front surface of the cover 36 of the housing 34. The display area 70 may be in the form of an overlay on the cover 36 or may be integrated into the cover 36 as part of an in-molded protective plastic cover film 72. The display area 70 can be used as a display area for graphics embedded in the cover 36, e.g., an in-mold decoration or advertising graphics. The cover 36 may be formed of opaque plastic except in the area over the camera lens 50, where the cover 36 is transparent or partially filtered to conceal the lens while still allowing image capture.

While many embodiments and modes for carrying out the present invention have been described in detail above, those familiar with the art to which this invention relates will recognize various alternative designs and embodiments for practicing the invention within the scope of the appended claims.

1. A wireless camera tag for a camera system including a mounting rail with one or more electrical conductors connected to a power source, the wireless camera tag comprising:
an outer housing configured to mount to the mounting rail proximate the one or more electrical conductors;
a digital camera attached to the outer housing and configured to generate image data signals; and
an inductor coil attached to the outer housing and electrically connected to the digital camera, the inductor coil being configured to inductively couple power from the one or more electrical conductors of the mounting rail and transmit the power to the digital camera.

2. The wireless camera tag of claim 1, wherein the inductor coil includes an air core coil.

3. The wireless camera tag of claim 1, further comprising a capacitor connected to the inductor coil to form a resonant circuit.

4. The wireless camera tag of claim 3, wherein the power transmitted by the resonant circuit is alternating current (AC) power, the wireless camera tag further comprising a rectifier circuit electrically connected to the resonant circuit and configured to convert the AC power into direct current (DC) power for transmission to the digital camera.

5. The wireless camera tag of claim 4, wherein the rectifier circuit includes a diode bridge.

6. The wireless camera tag of claim 1, further comprising a printed circuit board (PCB) disposed inside the outer housing, wherein the digital camera and the inductor coil are mounted on and electrically connected together by the PCB.

7. The wireless camera tag of claim 1, further comprising a wireless signal transmitter attached to the outer housing and electrically connected to the digital camera, the wireless signal transmitter being configured to transmit the image data signals generated by the digital camera to an external data-processing system.

8. The wireless camera tag of claim 1, wherein the outer housing is configured to detachably slidably couple to the mounting rail.

9. The wireless camera tag of claim 1, wherein the outer housing is a bipartite construction comprising a housing cover rigidly secured to a housing base.

10. The wireless camera tag of claim 1, characterized by a lack of an onboard power source mounted inside the outer housing.

11. The wireless camera tag of claim 1, characterized by a lack of an externally mounted electrical port or electrical connector for electrically connecting to an external power source.

12. An inventory management system for monitoring a stock level of a product on a display element, the inventory management system comprising:
a mounting rail operatively mounted proximate to the display element, the mounting rail including a pair of electrical conductors extending along the length of the mounting rail and configured to connect to a power source; and
a wireless camera tag including an outer housing detachably coupled to the mounting rail, a digital camera mounted at least partially inside the outer housing and configured to generate image data signals indicative of the stock level of the product on the display element, and a coupling coil mounted at least partially inside the outer housing and electrically connected to the digital camera, the coupling coil being configured to inductively couple power from the electrical conductors of the mounting rail and transmit the power to the digital camera.

13. The inventory management system of claim 12 in which said display element is at least one element selected from the group consisting of a shelf, a peg hook, and a wire basket.

14. The inventory management system of claim 12, wherein the power transmitted by the coupling coil is alternating current (AC) power, the wireless camera tag further comprising a rectifier circuit electrically connected to the coupling coil and configured to convert the AC power into direct current (DC) power for transmission to the digital camera.

15. The inventory management system of claim 12, wherein the coupling coil includes a capacitor connected in parallel with an inductor coil, and the rectifier circuit includes a diode bridge connected in parallel with the capacitor.

16. The inventory management system of claim 15, further comprising a printed circuit board (PCB) disposed inside the outer housing, wherein the digital camera, the capacitor, and the diode bridge are mounted on and electrically connected together by the PCB.

17. The inventory management system of claim 12, further comprising a wireless signal transmitter disposed inside the outer housing and electrically connected to the digital camera, the wireless signal transmitter being configured to transmit the image data signals generated by the digital camera to a processor of an external data-processing system.

18. The inventory management system of claim 12, further comprising a processor communicatively coupled to the wireless camera tag, the processor being configured to receive the image data signals generated by the wireless camera tag and determine from the image data signals via pattern recognition the stock level of the product on the display element.

19. The inventory management system of claim 18, further comprising an electronic display tag mounted proximate the display element and communicatively coupled to the processor, the processor being further configured to respond to a determination of an absence of the product on the display element by outputting a signal to the electronic display tag to display an out-of-stock message.

20. The inventory management system of claim 18 in which said camera tag includes a rechargeable energy source to support wireless transmission of large amounts of image data.

21. The inventory management system of claim 18 in which said camera tag includes a processor receiving said image data signals from said camera and processing said image data signals prior to transmission to reduce the amount of data to be transmitted.

22. The inventory management system of claim 21 in which said a processor is inductively coupled to a pricing management system through said electrical conductors on said mounting rail.

23. The inventory management system of claim 27 in which said processor is coupled to said camera to control image capture rate and data transmission timing and management.

24. An inventory management system for monitoring product displays, the inventory management system comprising:
a mounting rail operatively mounted proximate to the display element, the mounting rail including a pair of electrical conductors extending along the length of the mounting rail and configured to connect to a power source;
a wireless camera tag including an outer housing detachably coupled to the mounting rail, a digital camera mounted at least partially inside the outer housing and configured to generate image data signals indicative of the stock level of the product on the display element, and a coupling coil mounted at least partially inside the outer housing and electrically connected to the digital camera, the coupling coil being configured to inductively couple power from the electrical conductors of the mounting rail and transmit the power to the digital camera;
a processor receiving said digital images from said camera, said processor
detecting person stopped within the field of view of said camera, and
activating a selected display feature in response to the detection of a stopped person.

25. The inventory management system of claim 24 in which said display feature is a video display within or adjacent to the field of view of the camera.

26. The inventory management system of claim 24 in which said display feature is shelf lighting.

27. The inventory management system of claim 24 in which said processor detects and counts the number of moving objects passing through the field of view of said camera in successive preselected time periods, and deactivates said display features when said number is below a preselected threshold in at least one of said time intervals.

28. An inventory management system for monitoring product displays, the inventory management system comprising:
a mounting rail operatively mounted proximate to the display element, the mounting rail including a pair of electrical conductors extending along the length of the mounting rail and configured to connect to a power source;
a wireless camera tag including an outer housing detachably coupled to the mounting rail, a digital camera mounted at least partially inside the outer housing and configured to generate image data signals indicative of the stock level of the product on the display element, and a coupling coil mounted at least partially inside the outer housing and electrically connected to the digital camera, the coupling coil being configured to inductively couple power from the electrical conductors of the mounting rail and transmit the power to the digital camera;
a processor having access to said digital images from said camera, said processor
operating an object recognition application that detects people in said images, and whether the detected people stop in front of a product display in the field of view of the camera,
the number of people that stop in front of a product display in the field of view of the camera within each of successive preselected time intervals, and
the identity of the product in the display in front of which the detected people stopped.

29. The inventory management system of claim 28 which includes a memory storing a planogram of the desired display of products within the field of view of said camera, and said processor has access to said stored planogram.

30. The inventory management system of claim 28 in which said object recognition application detects changes in the number of products displayed in the field of view of said camera in said successive preselected time intervals.

31. The inventory management system of claim 28 in which said object recognition application identifies the gender of people that stop in front of a product display in the field of view of the camera, and transmits the gender identifications to a central server.

32. The inventory management system of claim 28 in which said object recognition application compares images of detected people with a data base of known people.

33. A method of assembling a wireless camera tag for a camera system with a mounting rail having electrical conductors connected to a power source, the method comprising:
providing an outer housing with a housing cover and a housing base, the outer housing being configured to mount to the mounting rail proximate the electrical conductors;
seating a printed circuit board (PCB) assembly on the housing base, the PCB assembly including a PCB, a digital camera mounted on the PCB and configured to generate image data signals, a wireless signal transmitter mounted on the PCB and configured to transmit the image data signals generated by the digital camera, a capacitor mounted on the PCB, and a diode bridge mounted on the PCB and electrically connected with the capacitor;
attaching a coupling coil to the PCB assembly such that the coupling coil is electrically connected with the capacitor, the coupling coil being configured to inductively couple power from the electrical conductors of the mounting rail and transmit the power to the digital camera via the capacitor and the diode bridge; and
rigidly securing the housing cover to the housing base such that the PCB assembly and the coupling coil are secured at least partially inside the outer housing.
